(19) United States
(12) Patent Application Publication
(10) Pub. No.: US 2015/0143179 A1
(43) Pub. Date: May 21, 2015

(54) System and Method for Progressive Fault Injection Testing

(71) Applicant: NETAPP, INC., Sunnyvale, CA (US)

(72) Inventors: Rajesh Desai, Sunnyvale, CA (US); Pranab Patnaik, Cary, NC (US); Ranjit Raveendran, Sunnyvale, CA (US)

(73) Assignee: NETAPP, INC., Sunnyvale, CA (US)

(21) Appl. No.: 14/081,750

(22) Filed: Nov. 15, 2013

(51) Int. Cl. G06F 11/36

(52) U.S. Cl. CPC G06F 11/3688
USPC 714/38.1

(57) ABSTRACT

A system and method for performing a progressive fault injection process to verify software is provided. In some embodiments, the method comprises loading a software product into the memory of a testbed computing system, wherein the software product includes a function and a statement that calls the function. A data structure is updated based on an error domain of the function. The calling statement is executed for each of one or more error return codes of the error domain. For each iteration of the execution, a call of the function by the calling statement is detected, and, in response, an error return code of the one or more error return codes is provided in lieu of executing the function. The software product is monitored to determine a response to the provided error return code. In some embodiments, the error return code to provide is determined by querying the data structure.

### TECHNICAL FIELD

The present description relates to software testing and, more specifically, to a method of injecting faults in order to test error responses.

### BACKGROUND

Despite the explosive growth in code complexity, modern software is actually more reliable than its predecessors. This is due in no small part to advances in testability and fault-recovery. Improved testbeds allow designers to investigate software responses to a wide array of error conditions including system panics, hangs, deadlocks, and livelocks. By studying these faults, designers are able to construct graceful responses to common and uncommon errors.

Fault injection is one technique commonly used to verify software. Fault injection involves modifying code behavior in order to produce a deliberate error. For example, a fault injection routine may modify a function to read an undefined variable or modify the function to perform an incorrect mathematical operation. The effects of the resulting error can then be studied as it propagates throughout the code.

Fault injection can be thorough, but it is not without drawbacks. For example, conventional fault injection is highly iterative. To achieve comprehensive coverage, code must be run and rerun until each statement is executed and each branch is traversed. Conventional fault injection can also be labor-intensive. Often, inserting injection points to verify each statement and branch is a manual process requiring a programmer to write a substantial amount of fault-injection code. This runs the risk of introducing errors if the fault-injection code is removed and dramatically increasing program size if it is left in place. While compile-time injection can be used to keep fault-injection instructions out of the release code, it may require the code to be recompiled every time a new fault is tested. Hours of compile time per test for a hundred thousand tests is often unacceptable. Run-time injection can be used to avoid recompiling, but often requires the fault-injection code to be permanently added to the functional code.

Conventional fault injection has been generally successful. However, for these reasons and others, conventional methods have inefficiencies that have become increasingly significant in light of the increasing number of code paths. Accordingly, a need exists for a streamlined testing process that delivers increased coverage with fewer iterations and less manual intervention.

### BRIEF DESCRIPTION OF THE DRAWINGS

The present disclosure is best understood from the following detailed description when read with the accompanying figures.

FIG. 1 is an organizational diagram of an exemplary software product according to aspects of the present disclosure.

FIG. 2 is a flow diagram of a method of progressive fault injection according to aspects of the present disclosure.

FIG. 3 is an organizational diagram of an exemplary software product undergoing progressive fault injection according to aspects of the present disclosure.

FIGS. 4-6 are representations of exemplary fault table data structures according to aspects of the present disclosure.

FIG. 7 is a flow diagram of a method of optimizing progressive fault injection utilizing retry points and early termination points according to aspects of the present disclosure.

FIG. 8 is an organizational diagram of an exemplary software product undergoing progressive fault injection according to aspects of the present disclosure.

FIG. 9 is a system diagram of a testbed system according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments. Finally, in view of this disclosure, particular features described in relation to one aspect or embodiment may be applied to other disclosed aspects or embodiments of the disclosure, even though not specifically shown in the drawings or described in the text.

Various embodiments include systems, methods, and computer programs that verify the operation of a software product by injecting faults into the code of the software product. In one example, a testbed system analyzes the software product to determine the error-signifying return codes of various functions. Fault injection points are inserted in the software product to monitor calls to these functions, and when calls are detected, an error return code is returned to the calling statement instead of executing the function. By stepping through the error return codes, the testbed system progressively tests the error domain of the functions in a structured fashion. As merely one advantage, this technique of verification can be easily automated to reduce time spent manually inserting fault injection points. It also improves thoroughness and test coverage and reduces the number of fault injection points compared to conventional fault injection techniques. In addition, it allows users to select alternate error domains to test the most common or most severe faults.

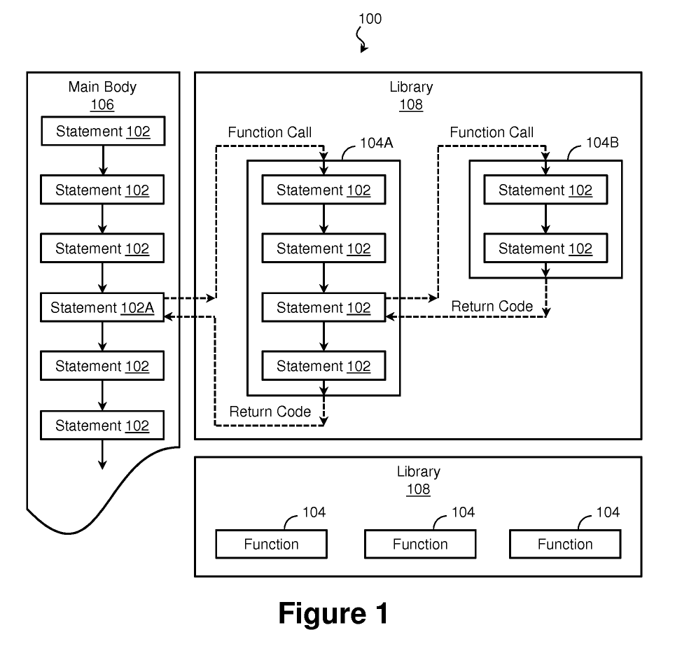

FIG. 1 is an organizational diagram of an exemplary software product 100 according to aspects of the present disclosure. The software product 100 comprises instructions executable by a computing system in order to control the operation of the computing system. The instructions may be represented in any suitable programming language. Examples include C, C++, C#, Java, Python, Perl, Javascript, Visual Basic, and any other suitable computer programming language. In some embodiments, the instructions of the software product are compiled or translated from a high-level language designed for ease of coding to a machine language capable of being executed by the computing system. In contrast, in some embodiments, the instructions of the software product are translated from an interpreted language into a machine language at runtime as an alternative to compiled instructions.

FIG. 1 illustrates the organization of an exemplary software product 100 by grouping instructions into statements 102 (including statement 102A). Statements 102 are groups of instructions of arbitrary size that are executed together (in series and/or in parallel) in order to perform an operation. Many, but not all, exemplary software products 100 have a flow such that executing one statement causes the computing system to execute a subsequent statement (in series and/or in parallel). Statements 102 may flow linearly from one statement 102 to the next, but may also branch by selecting from multiple possible subsequent statements 102.

Various program structures can be formed by grouping statements 102. For example, an arbitrary number of statements 102 can be grouped into a function 104. Functions 104 are often used to contain statements 102 that perform related tasks. Compartmentalizing statements 102 into functions 104 improves readability, testability, and protects variables within the function from being modified by unrelated instructions. Statements 102 that initiate a function 104 are said to call the function 104. Conceptually, the calling statement 102 can be thought of as pausing to wait for the function 104 to complete before proceeding. The calling statement may pass values (often referred to as parameters) to the called function 104. Similarly, the function 104 may return values to the calling statement 102. In one such example, a calling statement 102 provides a function 104 with a set of parameters, the function 104 performs one or more instructions on the received parameters, and the function 104 returns a value to the calling statement based on the results. Functions 104 may be written to return particular values that indicate the function 104 did not complete successfully. To provide additional diagnostic information, a function 104 may define a set of error return codes that classify particular failures. Based on the error return code and the associated fault, a calling statement 102 may take corrective action.

In the organizational diagram of FIG. 1, the software product 100 contains a set of statements 102 organized into a main body 106 and two libraries 108 of functions 104 (including functions 104A and 104B). In the illustrated embodiment, the statements 102 of the main body 106 are performed in sequence until statement 102A, which calls function 104A. At this point, the statements 102 of the main body 106 may pause until function 104A is complete. Any statement 102 may call a function 104 including a statement 102 within a function 104. In the illustrated embodiment, function 104A calls function 104B, and function 104A may pause until function 104B completes. Upon completion, a function 104 may provide a return value to the calling statement 102. In the example, function 104A provides a return value to the calling statement 102A. The returned value can then be used by the statements 102 of the main body 106. For example, statement 102A may utilize the returned value to determine the next statement 102 to perform (i.e., which branch to take).

Fault injection deliberately causes some portion of the software product 100 to fail in order to evaluate the effect and any corrective responses. In the ideal case, enough fault injection is performed on the software product 100 so that each statement 102 is executed (100% statement coverage) and each branch is traversed (100% branch coverage).

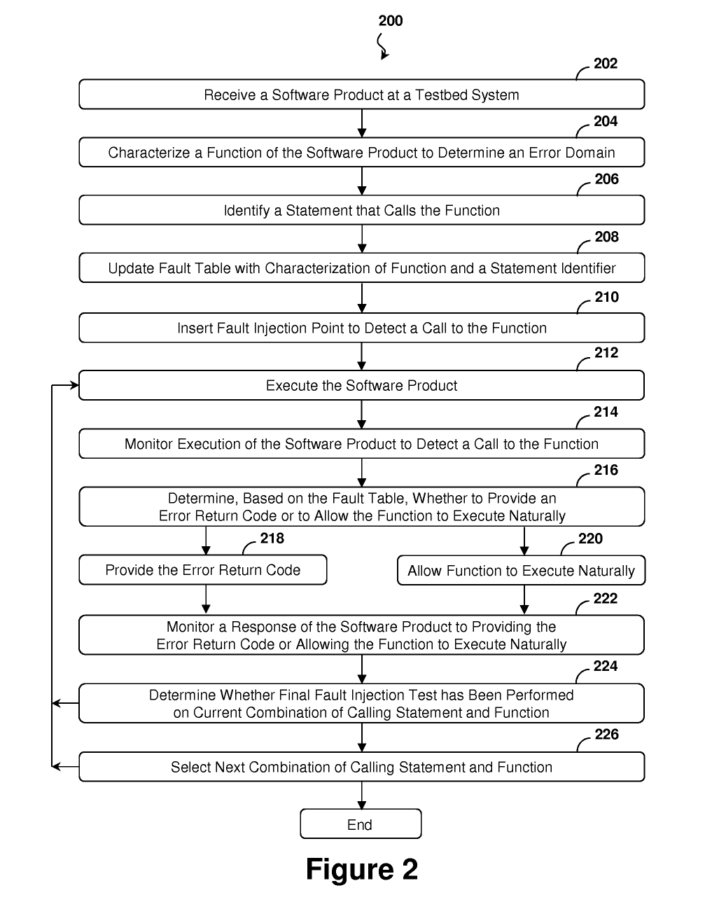

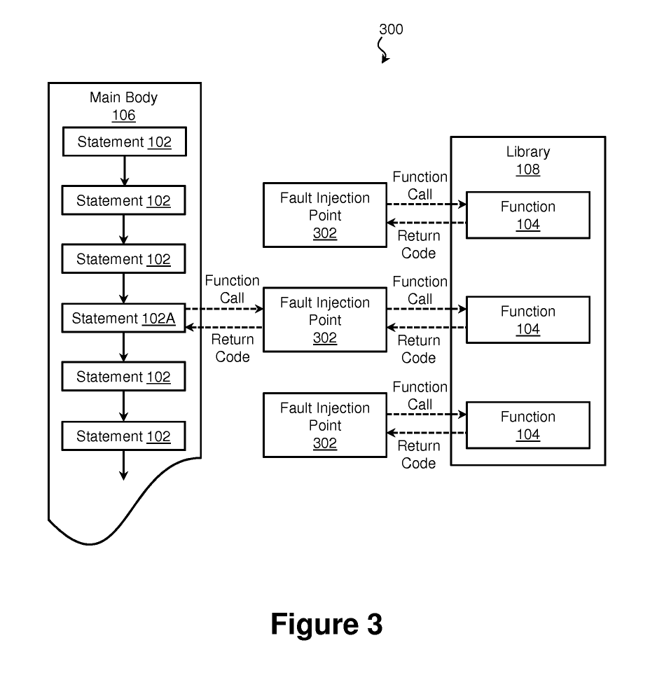

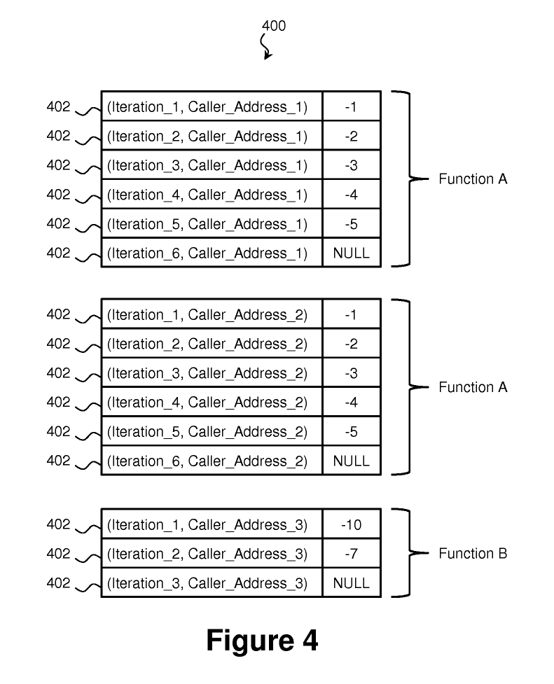

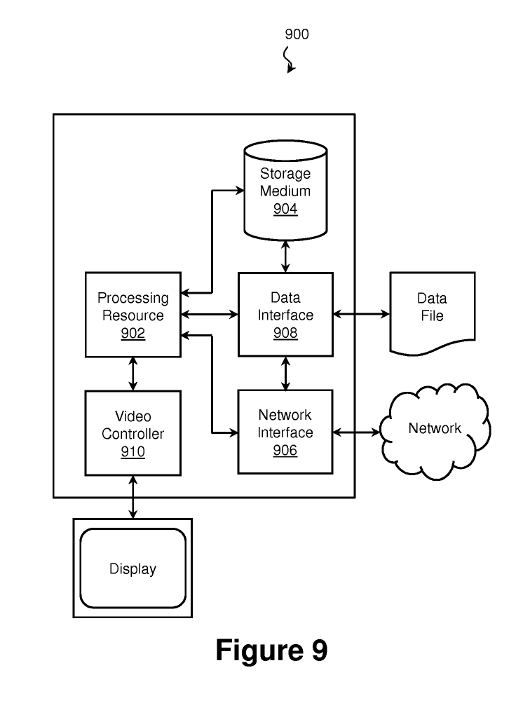

A method of fault injection is described with reference to FIGS. 2-6. FIG. 2 is a flow diagram of a method 200 of progressive fault injection according to aspects of the present disclosure. It is understood that additional steps can be provided before, during, and after the steps of method 200, and that some of the steps described can be replaced or eliminated for other embodiments of the method. The method 200 is suitable for performing using a testbed computing system such as the one disclosed below with respect to FIG. 9. FIG. 3 is an organizational diagram of an exemplary software product 300 undergoing progressive fault injection according to aspects of the present disclosure. FIGS. 4-6 are representations of exemplary fault table data structures according to aspects of the present disclosure.

As described in detail below, the method 200 determines a set of error return codes for a function 104 within a software product 300. Fault injection points 302 are added to the software product 300 to detect calls to the functions 104. The fault injection points 302 can execute the function 104 normally and can provide error return codes to the respective calling statements 102 as an alternative to executing the function 104. The software product 300 is then run for multiple iterations. In each iteration, when a function call is detected, a different error return code is provided. By stepping through each of the error return codes, the method 200 can test the response of the software product 300 to the error return codes and determine if the associated faults are handled correctly. During some iterations, the fault injection points 302 allow the functions to execute naturally and provide the appropriate return values to the respective calling statements 102. When the error domain of a given function 104 has been tested, the fault injection process may be repeated for other functions 104 in the software product 300.

Referring first to block 202 of FIG. 2 and to FIG. 3, a software product 300, including at least one function 104, is received at a testbed computing system. Typically, receiving includes loading uncompiled code of the software product 300 into the memory of the testbed computing system, although in some embodiments, portions of the software product 300 may be compiled prior to being received. The software product 300 of FIG. 3 may be substantially similar to the software product 100 disclosed with respect to FIG. 1, and in that regard may include statements 102 organized into a main body 106 and functions organized into a library 108, each substantially similar to those disclosed with respect to FIG. 1. In various embodiments, the received software product 300 includes any number of functions 104 and libraries 108.

Referring to block 204 of FIG. 2, the functions 104 of the software product 300 are identified and characterized. The characterization may include determining the range of possible return codes for each function 104 and may include determining return codes that signify errors within the function 104. The set of error return codes may be referred to as the error domain of a function 104. In an exemplary embodiment, the characterization determines the entire error domain for each function 104 of the software product 300. For consistency, some libraries 108 may require its functions to conform to a single error domain. Accordingly, characterizing the functions 104 of a library 108 may include determining the error return codes specific to the library 108. In some embodiments, certain error return codes are designated as more likely or more severe. Characterizing the functions 104 may include cross-referencing error return codes by likelihood and/or severity.

In an exemplary embodiment, the characterization of block 204 parses the compiled and/or uncompiled source code of the functions 104 of the software product 300 to determine instructions within the functions 104 that exit the respective functions 104 and return a value. From the instructions, the characterization determines which returns correspond to errors and further determine the associated error return codes. In a further exemplary embodiment, the characterization of block 204 parses a table separate from the software product 300 that lists functions and their corresponding error return codes.

Referring to block 206 of FIG. 2, the software product may be further characterized to identify the statements 102 that call the functions 104 characterized in block 204. Calling statements 102 may be assigned an identifier used to track the error return codes provided to the calling statements 102. In some embodiments, a calling statement 102 is identified by its memory address (return address) and the characterization includes cross-referencing each calling statement 102 with a respective memory address.

Referring to block 208 of FIG. 2 and to FIGS. 4, 5, 6, a fault table data structure stored on the testbed computing system is updated with the function 104 characterization of block 204 and the statement 102 identifier of block 206. The fault table data structure correlates the error domains of functions 104 with the calling statements 102. In this way, the fault table data structure can be used to provide the error return codes of the functions 104 to their respective calling statements 102. As described in more detail below, the subsequent fault analysis process of blocks 212-226 executes a calling statement of the software product 300 (including the calling statement 102) a number of times. In each iteration, a fault injection point 302 provides the calling statement 102 with a different error return code of the respective function 104. By progressing through the error return codes in an orderly manner, the response of the software product can be carefully monitored. The fault table data structure may take any suitable format including a linked list, a tree, a table such as a hash table, an associative array, a state table, a flat file, a relational database, and/or other memory structure. Exemplary data structures are described with reference to FIGS. 4, 5, and 6.

Referring to FIG. 4, an exemplary fault table data structure 400 is arranged as a hash table of key/value pairs. Each table entry 402 has a key corresponding to an address of a calling statement 102 and a progression identifier that signifies the iteration of the fault analysis. Each table entry 402 also has a value associated with the respective key, and in many embodiments, the keys corresponds to unique error return codes of the error domain. As disclosed above and in more detail below, in each iteration, the calling statement 102 is provided with a different error return code of the respective function 104 as determined by the progression identifier. Hash tables can be queried according to key values in order to obtain the associated value. Accordingly, in the exemplary embodiment, querying the fault table data structure 400 based on the address of a calling statement 102 and a progression identifier may return an error return code of the function 104 called by the calling statement 102.

In the illustrated embodiment, each function 104 has a table entry 402 for each combination of calling statement 102 address and error return code plus one additional table entry 402 corresponding to a natural return and having the value “null”. The error code table entries 402 cause a fault injection point 302 to return the corresponding error code instead of executing the function 104, while the natural table entry 402 causes the fault injection point to allow the function 104 to execute normally. For example, function A has an error domain of (−1, −2, −3, −4, −5). Correspondingly, function A has, for each calling statement 102, five table entries 402 corresponding to error return codes and one table entry 402 corresponding to a natural return. As shown in FIG. 4, “Caller_Address_{—}1” and “Caller_Address_{—}2” each correspond to a calling statement 102 that calls function A. Accordingly, each of “Caller_Address_{—}1” and “Caller_Address_{—}2” has five corresponding error code table entries 402 and one corresponding natural table entry 402. Likewise, “Caller_Address_{—}3” corresponds to a calling statement 102 that calls function B. Accordingly, “Caller_Address_{—}3” has two corresponding error table entries 402 based on the error domain of function B and one corresponding natural table entry 402. In the exemplary embodiment, each error code table entry 402 has a hash value equal to a unique error return code within the error domain, while the natural table entry 402 has a “null” hash value. In the illustrated embodiment, each error return code is tested before allowing the function to complete naturally, although it is understood that the natural execution of the function may take place at any time before, during, and/or after testing the error domain.

In the illustrated embodiment, the fault table data structure 400 includes table entries 402 for each error return code within an error domain. However, in some embodiments, fault injection testing is limited to a subset of the error domain. The subset may be determined based on commonality of a fault, severity of a fault, known errors, user identified faults, and/or other suitable criteria. In some such embodiments, the fault table data structure 400 includes only a subset of the error domain. In further such embodiments, the table entries 402 of the fault table data structure 400 include an identifier of the subset or subsets to which they belong. The identifier may be incorporated into the key and/or the value of the table entries 402.

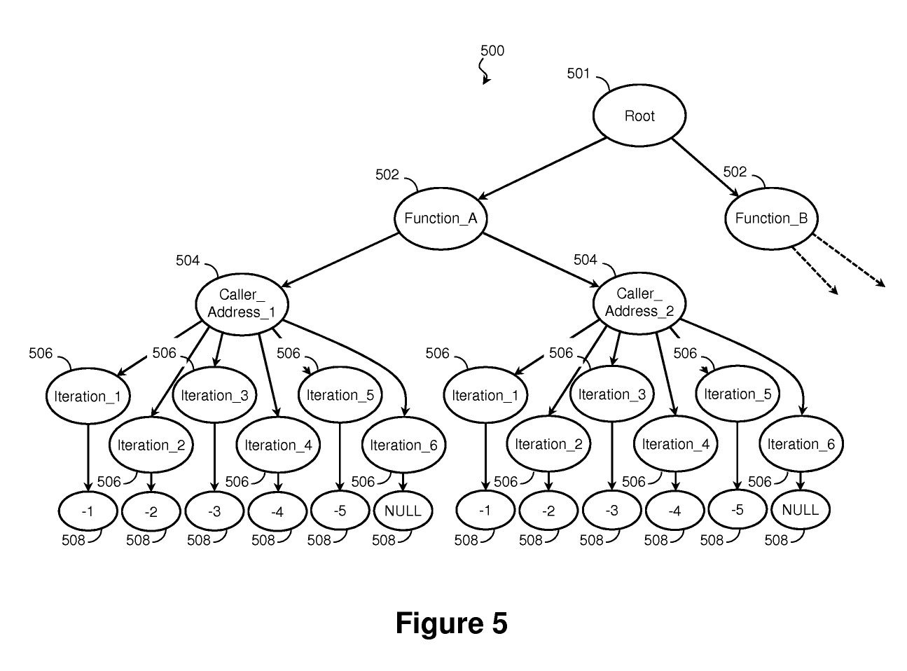

Referring to FIG. 5, another exemplary fault table data structure 500 is described. Data structure 500 may be substantially similar to data structure 400 of FIG. 4. The exemplary data structure 500 is arranged as a node-based search tree, although the concepts of data structure 500 may be applied to any other tree-based structure such as a binary tree. Instead of using hash keys, search trees are queried by beginning at the root node 501 and traversing from node to node by following the connectors until a terminal node is reached. In the exemplary data structure 500, the depth of the nodes determines the data contained therein. For example, the nodes of the first level 502 (optional) correspond to functions 104 of the software product 300. The nodes of the second level 504 correspond to addresses of calling statements 102. The nodes of the third level 506 correspond to progression identifiers. The nodes of the fourth level 508 (terminal nodes) correspond to error return codes within an error domain. In this representation, the tree of data structure 500 is traversed according to the function 104, calling statement 102 address, and progression identifier in order to determine an error return code to provide to the respective calling statement 102.

In the illustrated embodiment, each function 104 has a terminal node 508 for each combination of calling statement 102 address and error return code plus one additional terminal node 508 corresponding to a natural return. The error code terminal nodes 508 cause a fault injection point 302 to return the corresponding error code instead of executing the function 104, while the natural terminal node 508 causes the fault injection point to execute the function 104 normally. As in the example above, function A has an error domain of (−1, −2, −3, −4, −5). Correspondingly, function A has, for each calling statement 102, five terminal nodes 508 corresponding to error return codes and one terminal node 508 corresponding to a natural return. As shown in FIG. 4, “Caller_Address_{—}1” and “Caller_Address_{—}2” each correspond to a calling statement 102 that calls function A. Accordingly, each of “Caller_Address_{—}1” and “Caller_Address_{—}2” has five corresponding error code terminal nodes 508 and one corresponding natural terminal node 508. In the exemplary embodiment, each error code terminal node 508 has a value equal to a unique error return code within the error domain, while the natural terminal node 508 has a “null” value. In the illustrated embodiment, each error return code is tested before allowing the function to complete naturally, although it is understood that the natural execution of the function may take place at any time before, during, and/or after testing the error domain.

In the illustrated embodiment, the fault table data structure 500 includes terminal nodes 508 for each error return code within an error domain. However, in some embodiments, fault injection testing is limited to a subset of the error domain. The subset may be determined based on commonality of a fault, severity of a fault, known errors, user identified faults, and/or other suitable criteria. In some such embodiments, the fault table data structure 500 includes only a subset of the error domain. In further such embodiments, the nodes of the fault table data structure 400 include an identifier of the subset or subsets to which they belong. The identifier may take the form of another level of nodes between the root node 501 and the terminal nodes 508 or may be incorporated into the values of other nodes.

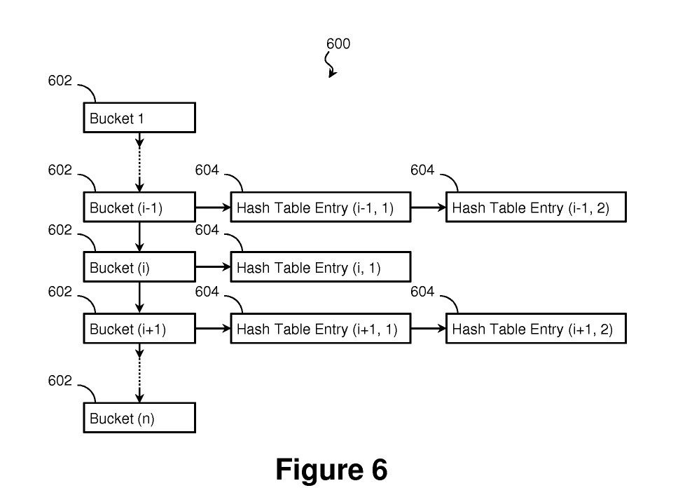

Finally, referring to FIG. 6, another possible example of a fault table data structure 600 is described. Data structure 600 may be substantially similar to data structure 400 of FIG. 4 and data structure 500 of FIG. 5. The exemplary data structure 600 is arranged as an n-dimensional array. At the top level, the data structure 600 includes buckets 602 that group together table entries 604 by key value. In that regard, each table entry 604 has a key/value pair, and accordingly, each bucket 602 contains a linked list of one or more table entries 604 having the same key. In this exemplary embodiment, the key is a combination of a test identifier (which may include the name of the software module being tested and/or other identifiers), a progression identifier, and/or a calling statement 102 address. Each table entry 604 has a value that is associated with the key and that includes the error return code to be provided. As can be seen, for each bucket 602, the table entries 604 of the bucket 602 include the error return codes of the error domain. The linked list of the bucket 602 may determine the order in which the error return codes are provided during verification. It is understood that the data structures of FIGS. 4-6 are merely exemplary, and other data structures are both contemplated and provided for.

Referring to block 210 of FIG. 2 and to FIG. 3, one or more fault injection points 302 are added to the software product 300. The fault injection points 302 detect calls to a function 104 and, based on the fault table data structure 400, determine whether to pass the function call to the associated function 104 or to return an error return code to the calling statement 102 in lieu of executing the function 104. The fault injection point may also be operable to modify returned values including error return codes sent by the function 104. In some embodiments, a unique fault injection point 302 is added for each function 104 within the software product 300, while in alternate embodiments, a single fault injection point 302 corresponds to more than one function and will detect calls to these corresponding functions. Even in embodiments where the fault injection points 302 have a 1:1 correspondence to functions 104, the total number of fault injection points 302 added may be significantly less than in those conventional methodologies where a unique fault injection point 302 is required for each error return code. Utilizing fewer fault injection points 302 may reduce the time and effort of adding the injection points 302, may reduce risk of introducing errors when adding or removing injection points 302, and may reduce overall code size of the software product 300.

In an exemplary embodiment, a fault injection point 302 is added by modifying the source code of the software product 300 and replacing a call to a function 104 with a call to the respective fault injection point 302. In a further exemplary embodiment, a fault injection point 302 is added by incorporating the fault injection point 302 into a wrapper surrounding the function 104 and/or the associated library 108. As can be seen, these techniques are easily automated and easily reversible. Other techniques are both contemplated and provided for.

As described in blocks 212-226 of FIG. 2, the fault table data structure 400 may be used to iteratively test each return code for each calling statement 102. Referring to block 212 of FIG. 2, the code of the software product 300 is executed by the testbed system. During execution, function calls within the software product 300 are monitored as shown by block 214.

Referring to block 216, when a function call is detected in block 214, the testbed system determines, based on the fault table data structure 400, whether to provide an error return code in lieu of executing the function or to execute the function and pass the “natural” return code to the calling statement 102. In various embodiments, this includes querying the fault table data structure 400 based on an identifier of the called function 104, an address of the calling statement 102, and/or a progression identifier. In the illustrated embodiment, each error return code is tested before allowing the function to complete naturally, although it is understood that the natural execution of the function may take place at any time before, during, and/or after testing the error domain.

If it is determined in block 216 that an error return code is to be provided instead of executing the function, in block 218, the error return code to be provided is determined from the fault table data structure 400 and is provided by the testbed system to the calling statement 102. In various embodiments, this includes querying the data structure 400 based on an identifier of the called function 104, an address of the calling statement 102, and/or a progression identifier. If it is determined in block 216 that the function is to be allowed to execute naturally, the function is executed in block 220. This may include passing a return code (which may signify an error or a successful completion) produced by the function 104 to the calling statement 102. Referring to block 222, the software product 300 is monitored to determine one or more responses to the provided error return code or the natural execution of the function.

Referring to block 224, the testbed system determines whether the final fault injection test has been performed for the current calling statement 102 and the current function 104. In some embodiments, each error code in the error domain is tested for the calling statement 102 and at least one natural return is performed before proceeding to the next calling statement 102. In some embodiments, the natural return is omitted. In some embodiments, only a subset of the error domain is tested for each combination of calling statement 102 and function 104. The subset may be determined based on commonality, severity, known errors, user identified faults, and/or other suitable criteria. If it is determined that the final fault injection test has not been performed, execution may be restarted in block 212 and another iteration of blocks 214-224 may be performed. If the final injection test has been performed, in block 226, the next combination of calling statement 102 and function 104 is selected for monitoring, and execution may be restarted in block 212. If the selection of block 226 indicates that all specified fault injection tests have been run for all specified combinations of calling statements 102 and functions 104, testing may be completed.

In the illustrated embodiment, the orderly progression through the error domain described in blocks 212-226 provides the error return codes in sequential order. However, this example is presented merely for clarity. In various embodiments, the error return codes provided in block 218 are provided in ascending order, descending order, and/or in a pseudo-random order where each error return code is provided at least once. Embodiments utilizing a pseudo-random order allow a user to determine whether the sequence of error return codes affects code behavior.

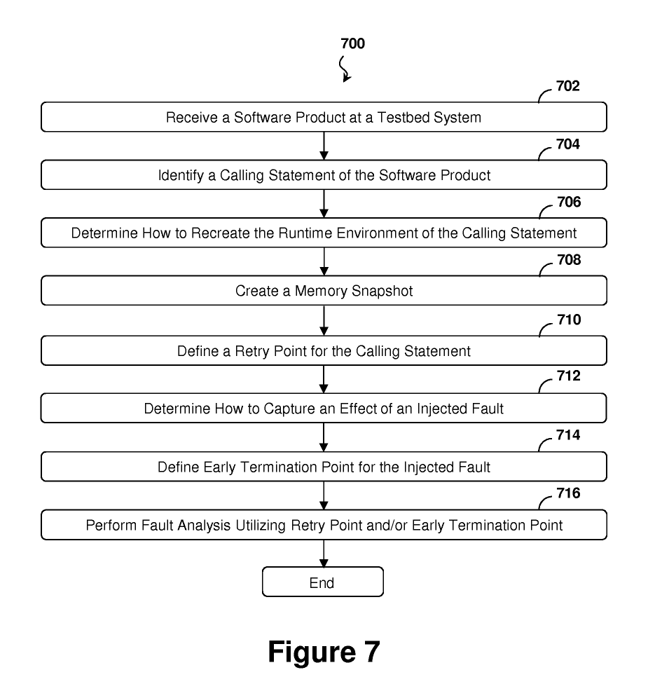

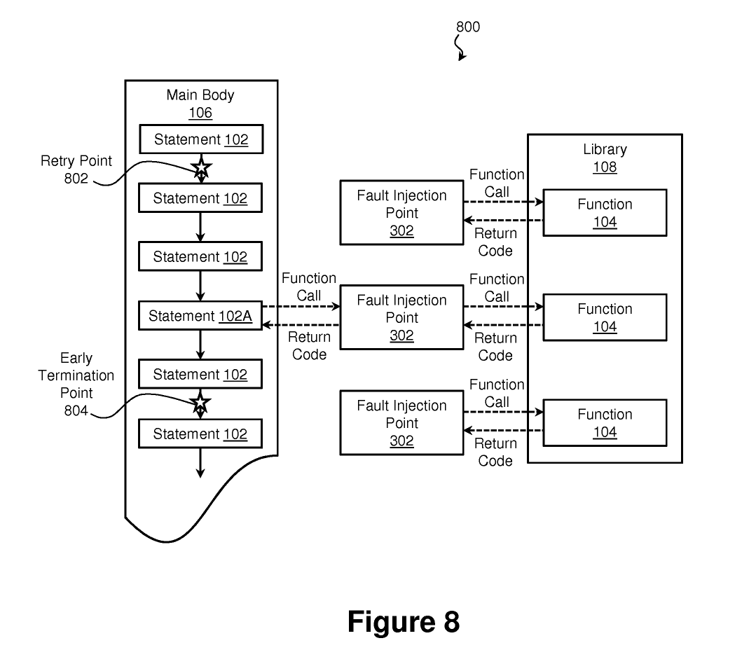

The method 200 improves verification efficiency over traditional fault injection techniques by reducing the number of fault injection points 302, by simplifying the process of adding fault injection points 302, and by an orderly progression through the errors of the error domain. However, the processes of method 200 may be further streamlined by utilizing retry points and early termination points to reduce the number of statements executed in each iteration. A method 700 of identifying and using retry points and early termination points in conjunction with progressive fault injection is described with reference to FIGS. 7 and 8.

FIG. 7 is a flow diagram of a method 700 of optimizing progressive fault injection utilizing retry points 802 and early termination points 804 according to aspects of the present disclosure. It is understood that additional steps can be provided before, during, and after the steps of method 700, and that some of the steps described can be replaced or eliminated for other embodiments of the method. The method 700 is suitable for performing in conjunction with method 200 of FIG. 2 and is further suitable for performing using a testbed computing system such as the one disclosed below with respect to FIG. 9. FIG. 8 is an organizational diagram of an exemplary software product 800 undergoing progressive fault injection according to aspects of the present disclosure.

As described in detail below, the method 700 identifies a statement 102 that calls a function 104 and determines a point in the flow preceding the calling statement 102 where execution can be restarted without affecting the behavior of the calling statement 102. This avoids restarting execution from scratch for every iteration of the fault injection process. The fewer statements between the retry point and the calling statement 102, the greater the performance benefits. However, efficiency may be balanced against idempotency and retriability. The method 700 may also determine a point in the flow following the calling statement 102 where failure analysis may be terminated without impacting analysis. Early termination also improves efficiency and delivers increasing benefit as the number of iterations rises.

Referring first to block 702 of FIG. 7 and to FIG. 8, a software product 800, including at least one function 104, is received at a testbed computing system. The software product 800 of FIG. 8 may be substantially similar to software product 100 disclosed with respect to FIG. 1 and/or software product 300 disclosed with respect to FIG. 3. In that regard, software product 800 may include statements 102 organized into a main body 106, functions organized into a library 108, and one or more fault injection points 302, each substantially similar to those disclosed with respect to FIGS. 1 and 3. As the method 700 is suitable for performing in conjunction with method 200 of FIG. 2, the received software product 800 of block 702 may be the software product received in block 202.

Referring to block 704 of FIG. 7 and to FIG. 8, a calling statement 102 (e.g., calling statement 102A) of the software product 800 is identified. The identification of the calling statement 102 of block 704 may be performed in conjunction with the identification of calling statements 102 in block 206 of FIG. 2.

Referring to block 706 of FIG. 7, the testbed system analyzes the runtime environment of the calling statement 102 to determine how to reliably recreate the environment without executing all of the preceding statements 102. The runtime environment includes local and global variables, memory values, register values, parameters and/or any other data value that may affect the execution of the calling statement 102. In some embodiments, the analysis determines a minimum portion of the runtime environment sufficient to provide retriability of the calling statement 102. A retriable calling statement 102 can be executed without errors caused by the recreated environment (i.e., without errors unrelated to the injected fault). In some embodiments, the analysis determines a minimum portion of the runtime environment sufficient to provide idempotency of the calling statement 102. An idempotent statement 102 exhibits the same behavior each time it is run with the same input. In further embodiments, the analysis determines a minimum portion of the runtime environment sufficient to provide both retriability and idempotency of the calling statement 102.

Referring to block 708 of FIG. 7, the testbed system may create a memory snapshot used to recreate the runtime environment in order to reduce the number of statements 102 executed. Loading the memory snapshot into memory has the effect of recreating a portion of the runtime environment, and by using a memory snapshot, the number of statements 102 executed may be reduced. In some embodiments, the memory snapshot includes one or more memory addresses and data stored at the respective addresses. In various such embodiments, the memory addresses correspond to random access memory, cache memory, registers, and/or any other suitable type of memory. In addition or in the alternative, the memory snapshot may include one or more variables and data values of the respective variables. The variables may include local variables, global variables, parameters, pointers, data structures, and data structure entries.

Referring to block 710, a retry point 802 may be set based on the environmental analysis of block 706 and, if applicable, the memory snapshot of block 708. The retry point identifies a statement 102 within the software program 800 where execution may begin in order to reliably perform fault injection analysis on a calling statement. Beginning a fault injection process at a retry point 802 that is not the first statement 102 of the software program 800 reduces the number of statements 102 executed in each iteration, thereby reducing both runtime and computing resources. In various embodiments, a retry point 802 is selected to provide retriability and/or idempotency of a respective calling statement 102. In some such embodiments, the retry point is selected to minimize the number of statements 102 executed while still providing retriability and/or idempotency of the calling statement 102. Multiple retry points 802 may be set, each corresponding to a unique calling statement 102.

Referring to block 712, a testbed system may analyze the error handling of the calling statement and/or one or more subsequent statements 102 to determine how to reliably capture the effects of an injected fault without executing all of the subsequent statements 102. Referring to block 714, an early termination point 804 may be set based on the analysis of block 712. The early termination point 804 identifies a statement 102 within the software program 800 where execution may reliably be halted while still providing sufficient diagnostic information for analyzing an injected fault. Similar to a retry point 802, ending a fault injection process at an early termination point 804 that is not a terminal statement 102 of the software program 800 reduces the number of statements 102 executed in each iteration. Accordingly, the early termination point 804 may be selected to minimize the number of statements 102 executed while still capturing the effects of an injected fault. Multiple early termination points 804 may be set, each corresponding to a unique calling statement 102.

Referring to block 716, fault injection is performed using the retry point 802 and/or the early termination point 804. The method 700 of optimizing progressive fault injection is suitable for use with any method of fault injection. When used in conjunction with the progressive fault injection of FIG. 2, the execution of the software product in block 212 may begin at a retry point 802 corresponding to the calling statement 102 and may load a memory snapshot in order to recreate a portion of the runtime environment. Similarly, the execution of the software program may terminate at an early termination point 804 corresponding to the calling statement 102.

FIG. 9 is a system diagram of a testbed system 900 according to aspects of the present disclosure. The testbed system 900 may include one or more processing resources 902 (e.g., microprocessors, microprocessor cores, microcontrollers, application-specific integrated circuits (ASICs), etc.), a non-transitory computer-readable storage medium 904 (e.g., a hard drive, flash memory, random access memory (RAM), optical storage such as a CD-ROM, DVD, or Blu-Ray device, etc.), a network interface device 906 (e.g., an Ethernet controller, wireless communication controller, etc.), a data interface 908 operable to receive and process data such as a computer software product to be verified, and a video controller 910 such as a graphics processing unit (GPU).

The present embodiments can take the form of an entirely hardware embodiment, an entirely software embodiment, or an embodiment containing both hardware and software elements. In that regard, in some embodiments, the testbed system 900 is programmable and is programmed to execute processes including those associated with fault injection testing such as the process of method 200 of FIG. 2 and/or method 700 of FIG. 7. Accordingly, it is understood that any operation of the testbed system 900 according to the aspects of the present disclosure may be implemented by the testbed system 900 using corresponding instructions stored on or in a non-transitory computer readable medium accessible by the processing system. For the purposes of this description, a tangible computer-usable or computer-readable medium can be any apparatus that can store the program for use by or in connection with the instruction execution system, apparatus, or device. The medium may include non-volatile memory including magnetic storage, solid-state storage, optical storage, cache memory, and Random Access Memory (RAM).

Thus, the present disclosure provides a system and method for verifying a software product using a progressive fault injection technique. In some embodiments, the method for validating software comprises: loading a software product into the memory of a testbed computing system, wherein the software product includes a function and a calling statement of the function; updating a data structure based on an error domain of the function; executing the calling statement for each of one or more error return codes of a subset of the error domain; and for each iteration of executing of the calling statement: detecting a call of the function by the calling statement during the iteration; in response to the detecting of the call of the function, providing an error return code of the one or more error return codes in lieu of executing the function, wherein the provided error return code corresponds to the iteration; and monitoring a response of the software product to the provided error return code. In one such embodiment, the method further comprises: further executing the calling statement; detecting a further call of the function by the calling statement during the further execution of the calling statement; in response to detecting the further call of the function, performing the function; and monitoring a response of the software product to performing the function.

In further embodiments, a computer system includes a processor and a non-transitory storage medium for storing instructions. The processor performs the following actions: loading a software product including a function and a calling statement of the function into a memory of the computer system; the method for fault injection testing comprises: receiving a software product including a function and a calling statement of the function; determining a set of error return codes of the function; detecting a call of the function by the calling statement; in response to the detecting of the call of the function, providing an error return code of the set of error return codes without executing the function; and monitoring a response of the software product to the error return code. In one such embodiment, the providing of the error return code of the set of error return codes includes providing each error return code of the set of error return codes. Furthermore, in one such embodiment, the set of error return codes is determined based on at least one of commonality, severity, known errors, and user identified faults

In yet further embodiments, the apparatus comprises: a non-transitory, tangible computer readable storage medium storing a computer program, wherein the computer program has instructions that, when executed by a computer processor, carry out: identifying a function of software product and further identifying a calling statement of the function; creating a data structure based on an error domain of the function; iteratively executing the calling statement for each of one or more error return codes of a subset of the error domain; and for each iteration of iterative executing of the calling statement: using a fault injection point, detecting a call of the function by the calling statement during the iteration; in response to the detecting of the call of the function, providing an error return code of the one or more error return codes by the fault injection point, wherein the provided error return code corresponds to the iteration; and monitoring a response of the software product to the provided error return code.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-based method for validating software, the method comprising:
loading a software product into the memory of a testbed computing system, wherein the software product includes a function and a calling statement of the function;
updating a data structure based on an error domain of the function;
executing the calling statement for each of one or more error return codes of a subset of the error domain; and
for each iteration of executing of the calling statement:
detecting a call of the function by the calling statement during the iteration;
in response to the detecting of the call of the function, providing an error return code of the one or more error return codes in lieu of executing the function, wherein the provided error return code corresponds to the iteration; and
monitoring a response of the software product to the provided error return code.

2. The method of claim 1 further comprising:
further executing the calling statement;
detecting a further call of the function by the calling statement during the further execution of the calling statement;
in response to detecting the further call of the function, performing the function; and
monitoring a response of the software product to performing the function.

3. The method of claim 1, wherein the providing of the error return code includes determining the error return code to provide using the data structure.

4. The method of claim 3, wherein the determining of the error return code to provide using the data structure includes querying the data structure based on an address of the calling statement and a progression identifier.

5. The method of claim 1, wherein the subset is determined based on at least one of commonality, severity, known errors, and user identified faults.

6. The method of claim 1, wherein each iteration of executing of the calling statement includes executing the software program starting from a retry point.

7. The method of claim 6, wherein the retry point is determined based on at least one of retriability and idempotency of the calling statement.

8. The method of claim 1, wherein each iteration of executing of the calling statement includes halting execution of the software program at an early termination point.

9. The method of claim 8, wherein the early termination point is determined based on a property of the response to be monitored.

10. A computer system including a processor and a non-transitory storage medium for storing instructions, the processor performing the following actions:
loading a software product including a function and a calling statement of the function into a memory of the computer system;
determining a set of error return codes of the function;
detecting a call of the function by the calling statement;
in response to the detecting of the call of the function, providing an error return code of the set of error return codes without executing the function; and
monitoring a response of the software product to the error return code.

11. The computer system of claim 10, where the providing of the error return code of the set of error return codes includes providing each error return code of the set of error return codes.

12. The computer system of claim 10, wherein the call of the function is a first call, and wherein the processor further performs:
detecting a second call of the function by the calling statement;
in response to detecting the second call, executing the function; and
monitoring a response of the software product to executing the function.

13. The computer system of claim 10, wherein the set of error return codes is determined based on at least one of commonality, severity, known errors, and user identified faults.

14. The computer system of claim 10, wherein the processors further performs iteratively executing the software product, wherein each iteration of the iteratively executing the software product begins execution from a retry point.

15. The computer system of claim 14, wherein the retry point is determined based on at least one of retriability and idempotency of the calling statement.

16. The computer system of claim 10, wherein the processor further performs iteratively executing the software product, wherein each iteration of the iteratively executing the software product halts execution at an early termination point.

17. An apparatus comprising: a non-transitory, tangible computer readable storage medium storing a computer program, wherein the computer program has instructions that, when executed by a computer processor, carry out:
identifying a function of software product and further identifying a calling statement of the function;
creating a data structure based on an error domain of the function;
iteratively executing the calling statement for each of one or more error return codes of a subset of the error domain; and
for each iteration of iterative executing of the calling statement:
using a fault injection point, detecting a call of the function by the calling statement during the iteration;
in response to the detecting of the call of the function, providing an error return code of the one or more error return codes by the fault injection point, wherein the provided error return code corresponds to the iteration; and
monitoring a response of the software product to the provided error return code.

18. The apparatus of claim 17, wherein the computer program has further instructions that carry out:
performing a further iteration of executing the calling statement;
detecting a further call of the function by the calling statement during the further iteration;
in response to detecting the further call of the function, performing the function; and
monitoring a response of the software product to performing the function.

19. The apparatus of claim 17, wherein the instructions that carry out the providing of the error return code include further instructions for determining the error return code to provide using the data structure.

20. The apparatus of claim 19, wherein the instructions that carry out the determining of the error return code to provide using the data structure include further instructions for querying the data structure based on an address of the calling statement and a progression identifier.
